(19) United States
(12) Patent Application Publication
(10) Pub. No.: US 2017/0120871 A1
(43) Pub. Date: May 4, 2017

(54) Windshield Cleaning System

(71) Applicant: Patricia Schmitt, Depew, NY (US)

(72) Inventor: Patricia Schmitt, Depew, NY (US)

(21) Appl. No.: 14/927,204

(22) Filed: Oct. 29, 2015

(51) Int. Cl. B60S 1/38; B08B 1/00

(52) U.S. Cl. CPC B60S 1/38; B08B 1/006; B60S 2001/3831

(57) ABSTRACT

A windshield cleaning system includes a vehicle that has a windshield and a pair of windshield wipers. Each of the windshield wipers includes a wiper blade that is removably coupled to an associated one of the windshield wipers. A pair of abrasive strips is provided. Each of the abrasive strips is attached to the wiper blade of an associated one of the windshield wipers. Thus, each of the abrasive strips frictionally removes debris from the windshield.

### BACKGROUND OF THE DISCLOSURE

### Field of the Disclosure

The disclosure relates to cleaning devices and more particularly pertains to a new cleaning device for removing debris from a windshield.

### SUMMARY OF THE DISCLOSURE

An embodiment of the disclosure meets the needs presented above by generally comprising a vehicle that has a windshield and a pair of windshield wipers. Each of the windshield wipers includes a wiper blade that is removably coupled to an associated one of the windshield wipers. A pair of abrasive strips is provided. Each of the abrasive strips is attached to the wiper blade of an associated one of the windshield wipers. Thus, each of the abrasive strips frictionally removes debris from the windshield.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a windshield cleaning system according to an embodiment of the disclosure.

FIG. 2 is a front view of an embodiment of the disclosure.

FIG. 3 is a back view of an embodiment of the disclosure.

FIG. 4 is a cross sectional view taken along line 4-4 of FIG. 2 of an embodiment of the disclosure.

FIG. 5 is a perspective in-use view of an embodiment of the disclosure.

FIG. 6 is a perspective view of an alternative embodiment of the disclosure.

### DESCRIPTION OF THE PREFERRED EMBODIMENT

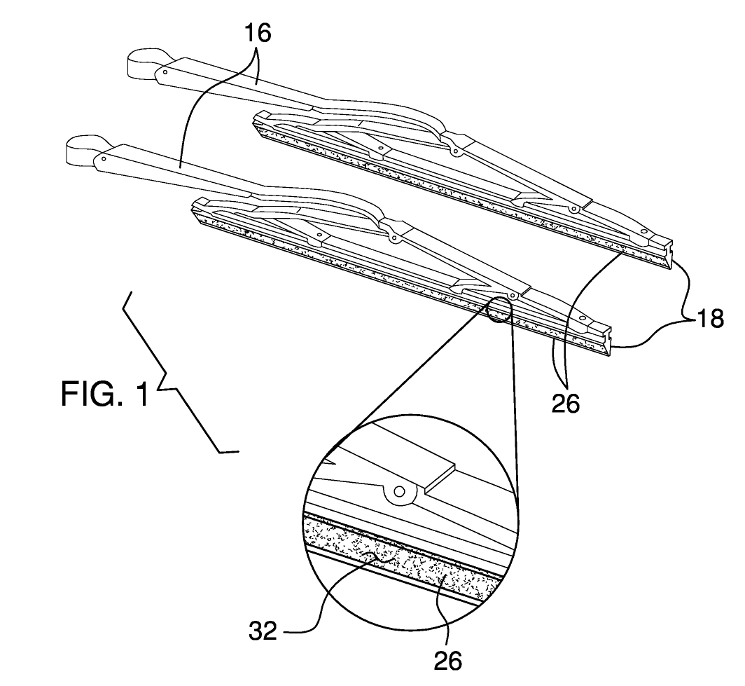

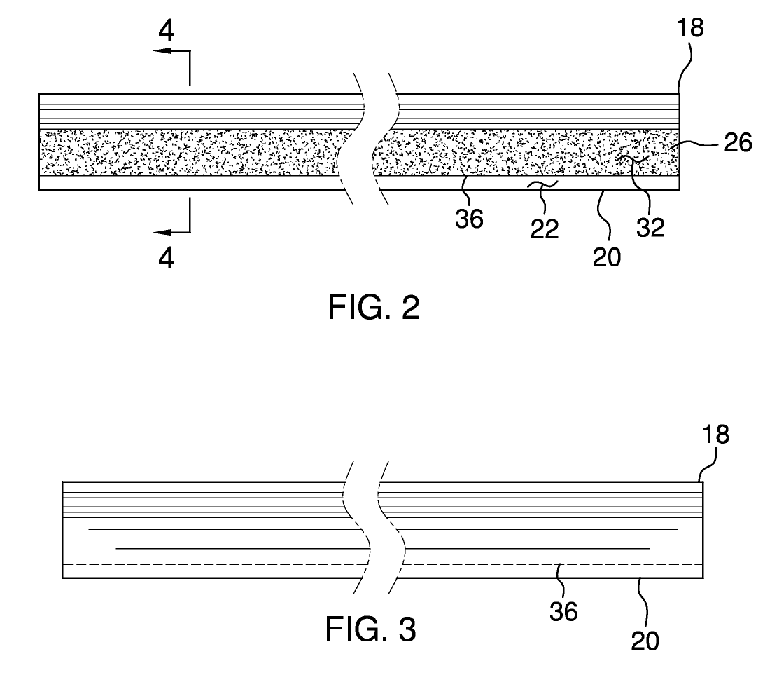

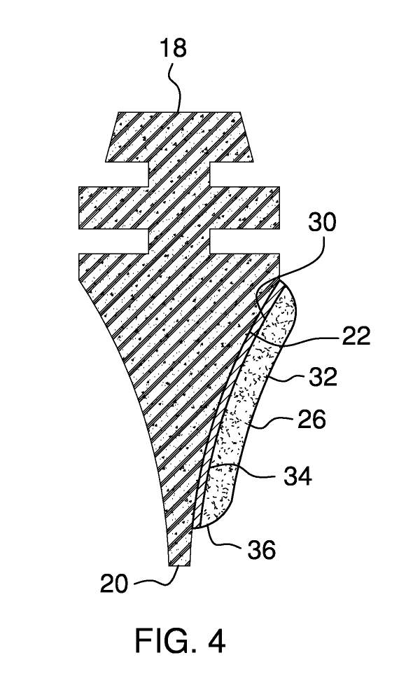

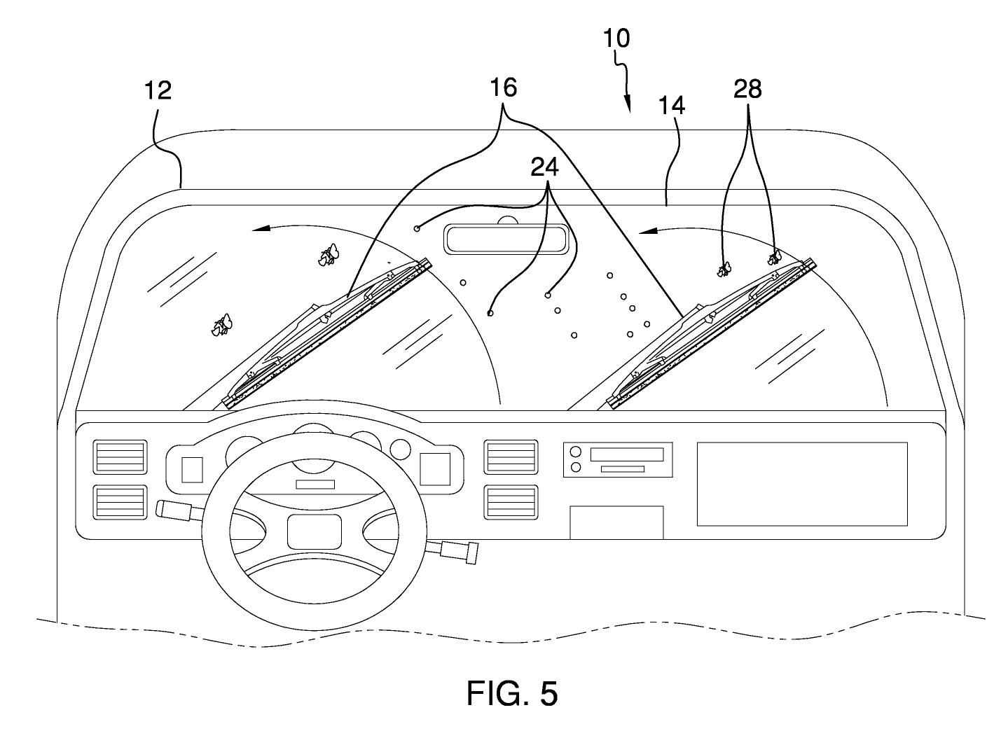

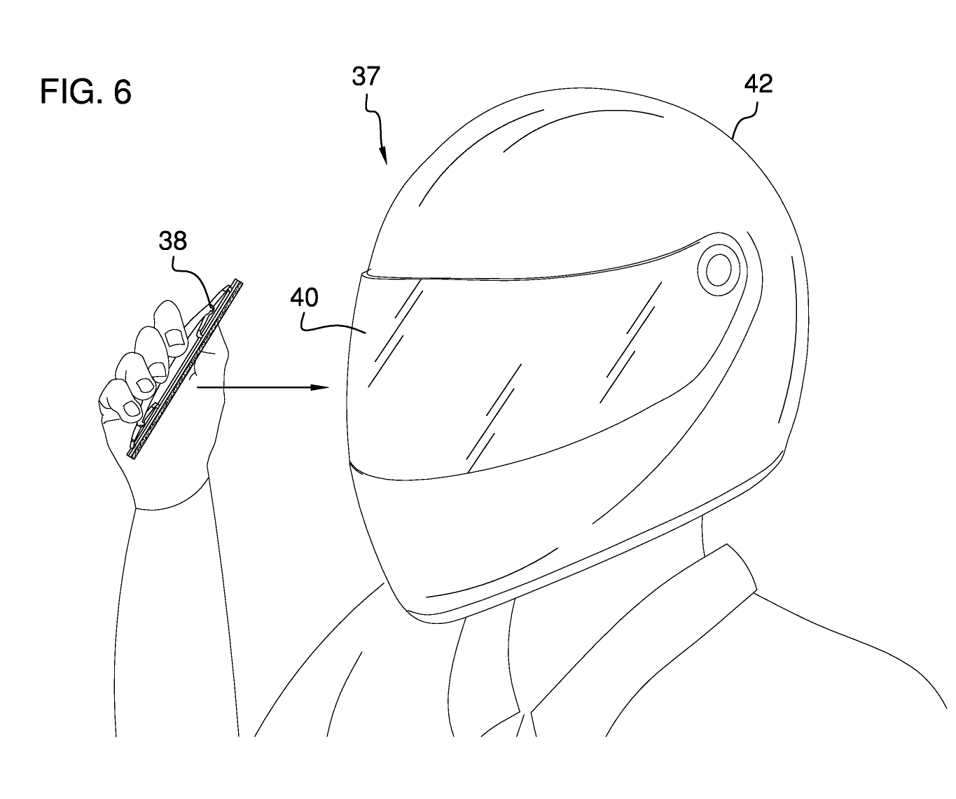

With reference now to the drawings, and in particular to FIGS. 1 through 6 thereof, a new cleaning device embodying the principles and concepts of an embodiment of the disclosure and generally designated by the reference numeral 10 will be described.

As best illustrated in FIGS. 1 through 6, the windshield cleaning system 10 generally comprises a vehicle 12 that has a windshield 14 and a pair of windshield wipers 16. Each of the windshield wipers 16 includes a wiper blade 18 that is removably coupled to an associated one of the windshield wipers 16. The wiper blade 18 has a distal edge 20 with respect to the associated windshield wiper 16. The wiper blade 18 has a first surface 22 extending between the associated windshield wiper 16 and the distal edge 20.

The distal edge 20 frictionally engages the windshield 14. The first surface 22 frictionally engages the windshield 14 when each of the windshield wipers 16 travels in a first direction. Thus, the wiper blade 18 removes moisture 24 from the windshield 14. The vehicle 12 may be a passenger vehicle or the like. The wiper blade 18 is comprised of a resiliently deformable material such as rubber. The wiper blade 18 may comprise a wiper blade installed by the vehicle manufacturer or an aftermarket wiper blade.

A pair of abrasive strips 26 is provided. Each of the abrasive strips 26 are attached the wiper blade 18 of an associated one of the windshield wipers 16. Each of the abrasive strips 26 frictionally removes debris 28 from the windshield 14. The debris 28 may comprise dead insects, dirt or other material typically deposited on the windshield 14 when the vehicle 12 is driven.

Each of the abrasive strips 26 has a first surface 30 and a second surface 32. The first surface 30 corresponding to each of the abrasive strips 26 comprises an adhesive layer 34. The second surface 32 of each of the abrasive strips 26 is textured. The adhesive layer 34 corresponding to each of the abrasive strips 26 adhesively engages the first surface 22 of the associated wiper blade 18. Thus, each of the abrasive strips 26 is retained on the associated wiper blade 18. Each of the abrasive strips 26 may be an integral component of the associated wiper blade 18.

Each of the abrasive strips 26 has a lower edge 36. The lower edge 36 of each of the abrasive strips 26 is spaced from the distal edge 20 of the associated wiper blade 18. Thus, the moisture 24 may travel between the lower edge 36 and the windshield 14 when the windshield wipers 16 travel in the first direction. Each of the abrasive strips 26 is coextensive with the associated wiper blade 18. The second surface 32 of each of the abrasive strips 26 frictionally engages the windshield 14 when the windshield wipers 16 travel in the first direction. Thus, the abrasive strips 26 remove the debris 28 from the windshield 14.

In an alternative embodiment 37 as shown in FIG. 6, each of the windshield wipers 16 may comprise a hand held windshield wiper 38. The windshield 14 may comprise a visor 40 on a helmet 42. The hand held windshield wiper 38 may be manually wiped across the visor 40 in the first direction. Thus, the moisture 24 and debris 28 are removed from the visor 40.

In use, windshield wipers 16 are turned on when rain falls or when the windshield 14 becomes covered with the debris 28. The abrasive strip 26 on each of the wiper blades 18 frictionally engages the windshield 14 when the windshield wipers 16 travel in the first direction. The abrasive strip 26 on each of the wiper blades 18 does not frictionally engage the windshield 14 when the windshield wipers 16 travel in a second direction.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A windshield cleaning system comprising:
a vehicle having a windshield and a pair of windshield wipers, each of said windshield wipers including a wiper blade being removably coupled to an associated one of said windshield wipers; and
a pair of abrasive strips, each of said abrasive strips being attached to said wiper blade of an associated one of said windshield wipers wherein each of said abrasive strips is configured to frictionally remove debris from said windshield, each of said abrasive strips has a first surface and a second surface, said first surface corresponding to each of said abrasive strips comprising an adhesive layer, said second surface of each of said abrasive strips being textured, said second surface of each said abrasive strip having rounded edges transitioning from an outer face towards said first surface of said abrasive strip.

2. The system according to claim 1, wherein said wiper blade has a distal edge with respect to said associated windshield wiper, said wiper blade having a first surface extending between said associated windshield wiper and said distal edge, said distal edge frictionally engaging said windshield, said first surface of said wiper blade frictionally engaging said windshield when each of said windshield wipers travels in a first direction wherein said wiper blade is configured to remove moisture from said windshield.

3. (canceled)

4. The system according to claim 1, wherein:
said wiper blade has a first surface; and
said adhesive layer corresponding to each of said abrasive strips adhesively engaging said first surface of said wiper blade of an associated one of said windshield wipers such that each of said abrasive strips is retained on said associated wiper blade, each of said abrasive strips being coextensive with said associated wiper blade.

5. The system according to claim 4, wherein said second surface of each of said abrasive strips frictionally engages said windshield when said windshield wipers travels in said first direction thereby facilitating said abrasive strips to remove the debris from said windshield.

6. A windshield cleaning system comprising:
a vehicle having a windshield and a pair of windshield wipers, each of said windshield wipers including a wiper blade being removably coupled to an associated one of said windshield wipers, said wiper blade having a distal edge with respect to said associated windshield wiper, said wiper blade having a first surface extending between said associated windshield wiper and said distal edge, said distal edge frictionally engaging said windshield, said first surface frictionally engaging said windshield when each of said windshield wipers travels in a first direction wherein said wiper blade is configured to remove moisture from said windshield; and
a pair of abrasive strips, each of said abrasive strips being attached to said wiper blade of an associated one of said windshield wipers wherein each of said abrasive strips is configured to frictionally remove debris from said windshield, each of said abrasive strips having a first surface and a second surface, said first surface corresponding to each of said abrasive strips comprising an adhesive layer, said second surface of each of said abrasive strips being textured, said adhesive layer corresponding to each of said abrasive strips adhesively engaging said first surface of said associated wiper blade such that each of said abrasive strips is retained on said associated wiper blade, each of said abrasive strips being coextensive with said associated wiper blade, said second surface of each said abrasive strip having rounded edges transitioning from an outer face towards said first surface of said abrasive strip, said second surface of each of said abrasive strips frictionally engaging said windshield when said windshield wipers travels in said first direction thereby facilitating said abrasive strips to remove the debris from said windshield.
